(19) United States
(12) Patent Application Publication
(10) Pub. No.: US 2022/0037958 A1
(43) Pub. Date: Feb. 3, 2022

(54) ROTOR CARRIER, DISK CARRIER, A SYSTEM COMPRISING BOTH AND A METHOD FOR PRODUCING THE SYSTEM

(71) Applicant: ZF Friedrichshafen AG, Friedrichshafen (DE)

(72) Inventors: Monika Rößner, Donnersdorf (DE); Gerald Viernekes, Hassfurt (DE); Simon Schuhmacher, Veitshöchheim (DE); Günter Fahl, Sulzfeld (DE); Peter Schömig, Güntersleben (DE)

(73) Assignee: ZF Friedrichshafen AG, Friedrichshafen (DE)

(21) Appl. No.: 17/387,488

(22) Filed: Jul. 28, 2021

(30) Foreign Application Priority Data
Jul. 28, 2020 (DE) 102020209460.8

(51) Int. Cl. H02K 7/108; B60K 6/387; B60K 6/24; B60K 6/26; H02K 7/00

(52) U.S. Cl. CPC H02K 7/108; B60K 6/387; B60K 6/24; B60Y 2400/61; H02K 7/006; B60Y 2200/92; B60K 6/26

(57) ABSTRACT

The present disclosure relates to a rotor carrier for an electric machine provided for the drive of a motor vehicle, which has, on the circumference, a rotor carrier connecting portion, which extends in a radial direction of the rotor carrier for connecting to a disk carrier connecting portion of a disk carrier of a multi-disk clutch. The present disclosure furthermore relates to a disk carrier for a multi-disk clutch for decoupling an electric machine provided for the drive of a motor vehicle from an internal combustion engine, which has, on the outer circumference, a disk carrier connecting portion for connecting to a rotor carrier connecting portion of a rotor carrier of the electric machine. The present disclosure furthermore relates to a system having a rotor carrier and a disk carrier as well as a method for producing such a system.

### CROSS-REFERENCE TO RELATED APPLICATION

This application claims priority to German Patent Application No. 102020209460.8 filed Jul. 28, 2020, the disclosure of which is incorporated herein by reference in its entirety.

### TECHNICAL FIELD

The disclosure relates to a rotor carrier for an electric machine, a disk carrier for a multi-disk dutch, a system having a rotor carrier and a disk carrier and a method for producing the system. More specifically, an electric machine is provided for driving a motor vehicle and a multi-disk clutch is provided for decoupling the electric machine from an internal combustion engine of the motor vehicle.

### BACKGROUND

As a drive, hybrid vehicles can generally have an internal combustion engine and an electric machine, which can be coupled to one another depending on the situation. Disconnect clutches, for example multi-disk clutches, can be used to couple and decouple the electric machine to or from the internal combustion engine.

It is known that a rotor carrier of the rotor of the electric machine is mutually axially connected to a disk carrier, for example an outer disk carrier, of the multi-disk clutch.

Even though a connection between the rotor carrier and the disk carrier is essentially known, there is a need to provide a connection between a rotor and a disk carrier, for example an outer disk carrier.

### SUMMARY

The present disclosure is directed to a rotor carrier, a disk carrier, a system having a rotor carrier and a disk carrier, as well as a method

A first aspect of the disclosure relates to a rotor carrier for an electric machine provided for the drive of a motor vehicle, which has, on the circumference, a rotor carrier connecting portion which extends in a radial direction of the rotor carrier for connecting to a disk carrier connecting portion of a disk carrier of a multi-disk clutch.

In some exemplary arrangements, the electric machine has a rotatable rotor and a fixed stator. The rotor comprises the rotor carrier which supports the rotor stack.

The electric machine can drive a motor vehicle in that it sets the motor vehicle in motion through the transmission of a drive force. In the case of an automobile, this typically takes place in that the force is transmitted to wheels of the motor vehicle. The motor vehicle is configured, for example, as an electric vehicle, as a vehicle having an internal combustion engine, as a hybrid vehicle or the like. The electric machine can also be operated as a generator and can thus generate electrical power in addition to the drive force.

The multi-disk clutch is typically provided for coupling or decoupling the electric machine to or from an internal combustion engine. However, the present disclosure is not restricted to this and the multi-disk clutch can be provided for the (de)coupling of other parts, for example another electric machine or a drive portion of the motor vehicle (e.g. a drive shaft, gear shaft, etc.).

The rotor carrier connecting portion is arranged circumferentially on the rotor carrier. In some exemplary arrangements, the rotor carrier is constructed to be symmetrical and an axis of symmetry of the rotor carrier extends along a centrally arranged longitudinal axis. For example, the rotor carrier can be designed to be cylindrical; an axis of symmetry then extends through the centrally arranged longitudinal axis of the rotor carrier. In this case, cylindrical shall also include hollow cylindrical. The rotor carrier can, for example, have a cross-section which is circular (without restricting the present disclosure thereto). In this case, circular shall also include annular. In some exemplary arrangements, the circumference now relates to a region which extends around the axis of symmetry; in the case of a circular cross-section, therefore, around the circular circumference of the cross-section. In some exemplary arrangements, the circumference corresponds to an outer and/or inner wall of the rotor carrier, which extends around the axis of symmetry. Consequently, in some exemplary arrangements, the circumferential arrangement is on and/or in a cylinder wall of the rotor carrier (and not on an end face of the rotor carrier, for example).

The rotor carrier connecting portion and the disk carrier connecting portion each represent a connecting element which is arranged circumferentially on the rotor carrier or on the disk carrier so that, in the assembled state, the rotor carrier connecting portion and the disk carrier connecting portion are connected to one another. Accordingly, the rotor carrier and the disk carrier can thus be connected to one another.

The rotor carrier can be designed to be hollow cylindrical, at least in a region in which the rotor carrier supports the rotor stack. In this case, the rotor carrier connecting portion is arranged circumferentially in this hollow cylindrical region. In some exemplary arrangements, the hollow cylindrical wall can have a thickness of 2 mm to 3 mm inclusive. For example, the hollow cylindrical wall can have a thickness of 2.5 mm.

The radial direction of the rotor carrier relates to the axis of symmetry of the rotor carrier. In the assembled state, the axis of symmetry of the rotor carrier corresponds to an axis of symmetry of the disk carrier. Accordingly, a radial direction of the disk carrier likewise relates to this axis of symmetry and therefore means a direction which extends, for example, perpendicularly to or away from the axis of symmetry. The axis of symmetry generally also corresponds to the axis of rotation of the rotor carrier or the disk carrier.

The rotor carrier and the disk carrier can be connected to one another by the rotor carrier connecting portion and the disk carrier connecting portion.

As a result of the rotor carrier connecting portion extending in the radial direction and being present circumferentially for connecting to the disk carrier connecting portion, it is possible to form a compact and/or stable connection between the rotor carrier connecting portion and the disk carrier connecting portion without needing to provide a connection in the axial direction, for example, as is the case when connecting the end face of the rotor carrier, for example.

Moreover, in some exemplary arrangements, a plurality of circumferential rotor carrier connecting portions are provided, which can be distributed over the circumference of the rotor carrier. An even connection over the circumferential surface of the rotor carrier and the disk carrier is thus possible, which is typically not possible in the case of an axial connection provided at the end face. In further exemplary arrangements, the plurality of circumferential rotor carrier connecting portions can be evenly distributed over the circumference of the rotor carrier. An even load on the connections between the rotor carrier and the disk carrier is thus possible.

In some exemplary arrangements, the rotor carrier connecting portion can be designed to form a material-fitting or form-fitting connection to the disk carrier connecting portion.

By a material-fitting connection, a connection is meant in which the rotor carrier connecting portion and the disk carrier connecting portion are held together by atomic or molecular forces. Such a material-fitting connection can be formed, for example, by soldering, welding or adhesion. The material-fitting connection can therefore be formed, for example, by laser welding and/or spot-welding.

A form-fitting connection can be formed by the mutual engagement of at least two connecting partners. Therefore, in some embodiments, the rotor carrier connecting portion and the disk carrier connecting portion can mutually engage to form a form-fitting connection. In this case, mutual engagement can mean that the one connecting partner is inserted into the other connecting partner, at least in some sections.

In further exemplary arrangements, the rotor carrier connecting portion can be designed to form both a material-fitting and a form-fitting connection to the disk carrier connecting portion.

As a result of the material- and/or form-fitting connection, the rotor carrier can be connected to the disk carrier in an at least rotationally fixed, if not additionally axially fixed, manner. By axially fixed, it is meant that, in the assembled state, the rotor carrier and the disk carrier are not displaceable, at least relative to one another, in the direction of the common axis of symmetry of the rotor carrier and the disk carrier.

In other exemplary arrangements, the rotor carrier connecting portion can have an indentation for realizing a radial force on the disk carrier. An indentation can generally be formed by a reshaping process, in which the surface of the workpiece, e.g. the rotor carrier present here, is reshaped by a forming tool, e.g. a punch. For example, the forming tool can be moved into the surface of the rotor carrier and can thus form the indentation.

By radial force, it is meant that a force acts in the radial direction of the rotor carrier and the disk carrier. In some exemplary arrangements, the indentation can be designed in such a way as to realize a radially inwardly acting force. In some exemplary arrangements, the indentation for realizing the radial force can be designed to be at least partly elastically deformable.

As a result of the rotor carrier connecting portion having the indentation for realizing the radial force, the rotor carrier can exert a spring force on the disk carrier in the assembled state of the rotor carrier and the disk carrier. Manufacturing tolerances can thus be compensated when connecting the rotor carrier to the disk carrier.

In further exemplary arrangements, a receiving hole for receiving the disk carrier connecting portion can be provided at the base of the indentation. The base of the indentation is, in other words, the bottom of the indentation.

In some exemplary arrangements, the receiving hole at the base of the indentation can be a through-opening, which extends in the radial direction of the rotor carrier. The rotor carrier connecting portion can mutually engage with the disk carrier connecting portion through the receiving hole and possibly form a form-fitting connection. The rotor carrier can thus be connected to the disk carrier in a stable manner.

In other exemplary arrangements, the rotor carrier connecting portion can have a stud for engaging with the disk carrier connecting portion. In further exemplary arrangements, the stud can project radially inwards. A stud is generally a portion protruding or projecting from a surface of a component for connecting to a second component. The stud is provided to engage in the disk carrier connecting portion. In other words, the stud is designed to project or slide into the disk carrier connecting portion. The rotor carrier connecting portion can form a form-fitting connection to the disk carrier connecting portion by the stud. The rotor carrier can thus be connected to the disk carrier in a stable manner.

In some exemplary arrangements, the stud can have a head for engaging behind the disk carrier connecting portion. The head is the portion of the stud which is arranged on a free end of the stud. In some exemplary arrangements, the head, as seen in the longitudinal direction of the stud, has a larger cross-section than the stud or stud neck. The stud neck is the portion of the stud which is arranged between the stud head and the surface from which the stud projects. The stud can engage behind the disk carrier connecting portion by the head, wherein the disk carrier connecting portion in some exemplary arrangements has an undercut for this purpose. The stud head is therefore designed in such a way as to enable a form-fitting connection between the rotor carrier and the disk carrier connecting portion in at least a radial direction of the rotor carrier. The rotor carrier connecting portion can thus form a stable connection to the disk carrier connecting portion. The rotor carrier and the disk carrier can furthermore thus be connected to one another in a radially fixed manner.

A second aspect of the disclosures relates to a disk carrier for a multi-disk clutch for decoupling an electric machine provided for the drive of a motor vehicle from an internal combustion engine, which has, on the outer circumference, a disk carrier connecting portion for connecting to a rotor carrier connecting portion of a rotor carrier of the electric machine.

The statements made with regard to the first aspect also apply, in a possibly corresponding manner, to the second aspect of the disclosure.

In some exemplary arrangements, the above-described disk carrier can be an outer disk carrier. Multi-disk clutches generally have at least one inner disk and at least one outer disk. In some exemplary arrangements, the outer disks can be received by an internally toothed tubular or, in other words, hollow cylindrical carrier, which is referred to accordingly as the outer disk carrier.

The disk carrier connecting portion is arranged on the outer circumference of the disk carrier. In some exemplary arrangements, the disk carrier is constructed to be symmetrical and an axis of symmetry of the disk carrier extends along a centrally arranged longitudinal axis. For example, the disk carrier can be designed to be cylindrical; an axis of symmetry then extends through the centrally arranged longitudinal axis of the disk carrier. In this case, cylindrical shall also include hollow cylindrical. The disk carrier can have, for example, a cross-section which is circular (without restricting the present disclosures thereto). In this case, circular shall also include annular. In some exemplary arrangements the circumference now relates to a region which extends around the axis of symmetry; in the case of a circular cross-section, therefore, around the circular circumference of the cross-section.

In some exemplary arrangements, the circumference corresponds to an outer and/or inner wall of the disk carrier, which extends around the axis of symmetry. Consequently, in some exemplary arrangements, the outer circumferential arrangement is on and/or in an outer cylinder wall of the disk carrier (and not on an end face of the disk carrier, for example).

In one exemplary arrangement, the disk carrier can be designed to be hollow cylindrical, at least in a region in which the disk carrier supports the outer disks. In this case, the disk carrier connecting portion is arranged on the outer circumference in this hollow cylindrical region. In some exemplary arrangements, the hollow cylindrical wall can have a thickness of 3 mm to 5 mm inclusive. For example, the hollow cylindrical wall can have a thickness of 2.5 mm.

The disk carrier connecting portion can comprise a region on the outer wall of the disk carrier. The region is therefore a portion of the surface of the outer wall of the disk carrier. In other words, the region is merely a portion of the outer wall of the disk carrier which does not comprise an additionally formed connecting element. Alternatively or additionally, the disk carrier connecting portion can have an outer circumferential connecting element for connecting to the rotor carrier connecting portion. By connecting element, it is meant that the disk carrier connection portion additionally has a structure or element, for example a stud, a receiving opening or the like, whereby the disk carrier connecting portion can form a form-fitting or material-fitting connection to the rotor carrier connecting portion.

As a result of the disk carrier connecting portion being present on the outer circumference for connecting to the rotor carrier connecting portion, it is possible to form a compact and/or stable connection between the rotor carrier connecting portion and the disk carrier connecting portion, without needing to provide a connection in the axial direction, for example, as is the case when connecting the end face of the disk carrier, for example.

Moreover, in some exemplary arrangements, a plurality of circumferential disk carrier connecting portions are provided, which can be distributed over the circumference of the disk carrier. An even connection over the circumferential surface of the rotor carrier and the disk carrier is thus possible, which is typically not possible in the case of an axial connection provided at the end face. In further exemplary arrangements, the plurality of circumferential rotor carrier connecting portions can be evenly distributed over the circumference of the rotor carrier. An even load on the connections between the rotor carrier and the disk carrier is thus possible.

In some exemplary arrangements, the disk carrier connecting portion can be designed in such a way as to form a material-fitting or form-fitting connection to the rotor carrier connecting portion. In further exemplary arrangements, the disk carrier connecting portion can be designed to form both a material-fitting and a form-fitting connection to the rotor carrier connecting portion. As a result of the material- and/or form-fitting connection, the disk carrier can be connected to the rotor carrier in an at least rotationally fixed, if not additionally axially fixed, manner.

In some exemplary arrangements, the disk carrier connecting portion can extend in a radial direction of the disk carrier for connecting to the rotor carrier connecting portion. In this case, the disk carrier connecting portion can extend radially inwards or outwards. As a result of the radial extent of the disk carrier connecting portion, this can form a connection to the rotor carrier connecting portion which represents a radial connection instead of an axial connection. The disk carrier and the rotor carrier can thus be connected to one another in a compact and/or stable manner without needing to provide a connection in the axial direction, for example, as is the case when connecting the end face of the disk carrier, for example.

In further exemplary arrangements, the disk carrier connecting portion can be designed to form a form-fitting connection to the rotor carrier connecting portion, The disk carrier can therefore be connected to the rotor carrier in an at least rotationally fixed, if not additionally axially fixed, manner.

In some exemplary arrangements, the disk carrier connecting portion can have a receiving opening for receiving the rotor carrier connecting portion. This receiving opening can be a through-opening in the disk carrier, which extends from the outer wall to an inner wall of the disk carrier. Alternatively, the receiving opening can have a receiving cavity, which is provided in the cylinder wall of the disk carrier and is open towards the outer wall of the disk carrier.

The receiving opening is provided to receive a correspondingly designed rotor carrier connecting portion, so that a radial connection can be formed between the disk carrier and the rotor carrier. The disk carrier can thus be connected to the rotor carrier in a compact and/or stable manner.

In further exemplary arrangements, the receiving opening can have an undercut. The undercut can be arranged on a side of the receiving opening which is opposite the outer wall of the disk carrier. The undercut enables a correspondingly designed rotor carrier portion to engage behind the receiving opening. A stable form-fitting connection can therefore be formed between the disk carrier connecting portion and the rotor carrier connecting portion.

In other exemplary arrangements, the disk carrier connecting portion can have a stud for engaging with the rotor carrier connecting portion. In further exemplary arrangements, the stud can project radially outwards. With the aid of the stud, the disk carrier connecting portion can mutually engage with a correspondingly designed rotor carrier connecting portion and therefore form a form-fitting connection.

In further exemplary arrangements, the stud of the disk carrier connection portion can have a head for engaging behind the rotor carrier connecting portion. The disk carrier can thus form a stable form-fitting connection to the rotor carrier connecting portion. in this way, the rotor carrier and the disk carrier can furthermore be connected to one another in a radially fixed manner.

A third aspect of the disclosure relates to a system having an above-described rotor carrier and an above-described disk carrier, wherein the rotor carrier and the disk carrier are connected to one another via the rotor carrier connecting portion and the disk carrier connecting portion. In some exemplary arrangements, the rotor carrier and the disk carrier can be made from steel. However, other suitable materials are also possible. Different materials for the rotor carrier and the disk carrier are furthermore possible.

A fourth aspect of the disclosure relates to a method for producing the above system. The method comprises the steps:

forming the rotor carrier connecting portion or the disk carrier connecting portion;

arranging the disk carrier in the rotor carrier; and

forming a material-fitting or form-fitting connection with the aid of the rotor carrier connecting portion and the disk carrier connecting portion.

In this case, the formation of the connecting portions on the rotor carrier or the disk carrier can comprise primary shaping, reshaping or joining processes or a combination thereof. Other suitable processes are also possible.

In some exemplary arrangements, the disk carrier can be designed as an outer disk carrier and the disk carrier can therefore be arranged in the rotor carrier.

A material-fitting or form-fitting connection between the rotor carrier and the disk carrier is formed by the rotor carrier connecting portion and the disk carrier connecting portion. To this end, the method can comprise further steps, which form a corresponding disk carrier connecting portion or a corresponding rotor carrier connecting portion which corresponds to the rotor carrier connecting portion or disk carrier connecting portion already formed.

In further exemplary arrangements, the formation of the rotor carrier connecting portion or the disk carrier connecting portion can comprise an indentation in a surface of the rotor carrier or a surface of the disk carrier. In this case, the surface can be located on the inner or outer wall of the rotor carrier or disk carrier, for example. In some exemplary arrangements, the indentation can comprise a reshaping of the surface of the rotor carrier or the disk carrier by a forming tool, for example a punch.

### BRIEF DESCRIPTION OF THE DRAWINGS

Exemplary arrangements of the disclosure are now described by way of example and with reference to the accompanying figures, in which:

FIG. 1 shows a system having a rotor carrier and a disk carrier according to a first exemplary arrangement;

FIG. 2 shows a connection between the rotor carrier and the disk carrier of FIG. 1;

FIG. 3 shows a perspective view of the system of FIG. 1;

FIG. 4 shows a connection between a rotor carrier and a disk carrier according to a second exemplary arrangement;

FIG. 5 shows a connection between a rotor carrier and a disk carrier according to a third exemplary arrangement;

FIG. 6 shows a connection between a rotor carrier and a disk carrier according to a fourth exemplary arrangement; and

FIG. 7 shows a method for producing a system having a rotor carrier and a disk carrier.

### DETAILED DESCRIPTION

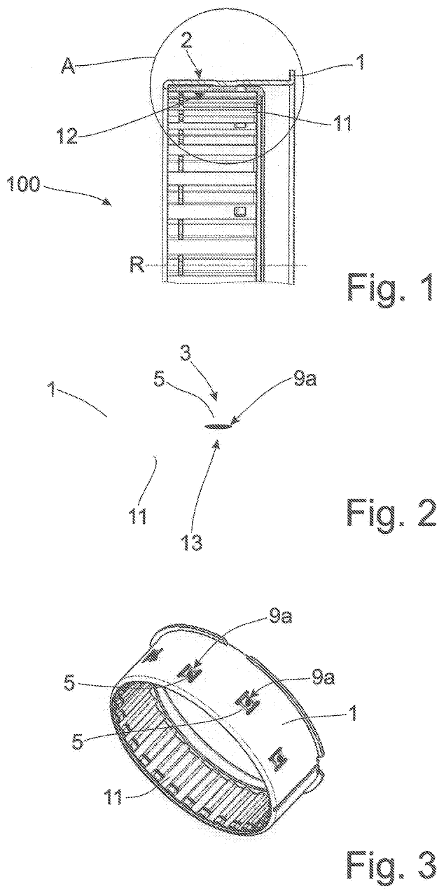

In FIG. 1, a system 100 is shown, which has a rotor carrier 1 and a disk carrier 11, which are designed and connected to one another according to a first exemplary arrangement. The rotor carrier 1 supports a rotor stack (not shown) and is part of a rotor of an electric machine (not shown). The rotor carrier 1 has a hollow cylindrical portion 2.

The disk carrier 11 is designed as an outer disk carrier of a multi-disk dutch, which is provided as a disconnect dutch 1 and has a hollow cylindrical portion 12. The disk carrier 11 is furthermore arranged in the rotor carrier 1 and is generally pushed therein. In the assembled state, the rotor carrier 1 and the disk carrier 11 have a common longitudinal axis or axis of symmetry R.

FIG. 2 shows an enlargement (not drawn to scale) of region A of FIG. 1. The rotor carrier 1 has a rotor carrier connecting portion 3 on the circumference of its hollow cylindrical portion 12. The rotor carrier connecting portion 3 has an indentation 5, which is illustrated schematically and extends radially inwards. The indentation 5 is configured in such a way that it exerts a radially inwardly acting spring force on the disk carrier 11, which is arranged in the rotor carrier 1.

In the exemplary arrangement shown, the indentation 5, as viewed in the circumferential direction of the rotor carrier 1, has a trapezoidal cross-section. Other cross-sections are also possible provided they realize the above-described spring force and the indentation 5 is suitable for welding to the disk carrier connecting portion 13.

The disk carrier 11 has a disk carrier connecting portion 13. In the arrangement shown here, the disk carrier connecting portion 13 corresponds to a region of the outer wall of the hollow cylindrical portion 12 of the disk carrier 11, wherein the region is in at least partial contact with the indentation 5. The rotor carrier connecting portion 3 and the disk carrier connecting portion 13 form a form-fitting connection 9a, which can be formed, for example, by laser welding or spot-welding. The rotor carrier 1 and the disk carrier 11 are thus connected to one another in a rotationally fixed and axially fixed manner.

In other alternatives (not shown), the indentation 5 can be designed in such a way that the spring force realized thereby is strong enough for the indentation 5 to form a force-fitting connection to the disk carrier connecting portion 13 and for the rotor carrier 1 to therefore be connected to the disk carrier 11.

FIG. 3 shows a perspective view of the system of FIG. 1. The rotor carrier 1 has a plurality of indentations 5 over its entire circumference, which are evenly distributed in the circumferential direction of the rotor carrier 11. In other words, the indentations 5 are evenly spaced from one another in the circumferential direction. Alternatively, the indentations 5 can be unevenly distributed in the circumferential direction, i.e. they can be at different spacings from one another.

The indentations 5 are welded to the disk carrier connecting portions 13 of the disk carrier 11 and form material-fitting connections 9a. Alternatively, only some of the plurality of indentations 5 may be welded to the disk carrier 11.

The indentations 5 are furthermore arranged in different positions as seen in the axial direction of the axis R. An improved load distribution can thus take place via the indentations 5. Alternatively, the indentations can be arranged in the same position in the axial direction, for example centrally on the circumference of the rotor carrier 1.

In further exemplary arrangements (not shown), only a single indentation 5 may be provided. Additionally, this single indentation 5 can extend along the entire circumference in the circumferential direction of the rotor carrier 1 and, furthermore additionally, the single indentation 5 can be welded to the rotor carrier at least partially, if not completely, along its circumference.

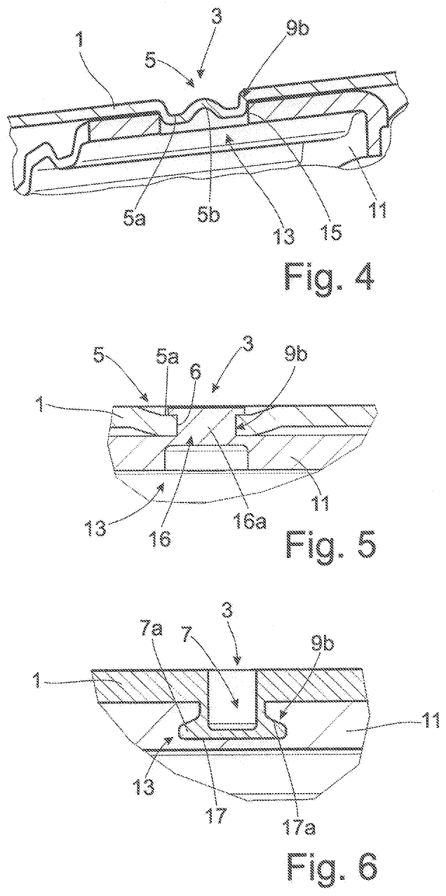

FIG. 4 shows a second exemplary arrangement for the rotor carrier 1 and the disk carrier 11. The indentation 5 here has a base 5a and a raised portion 5b, wherein the raised portion 5b is arranged on the base 5a and projects radially outwards. As a result of the raised portion 5b, the indentation 5 can be elastically deformed in the radial and/or axial direction, so that the indentation 5b can have a spring effect. In some embodiments, the disk carrier 11 can be arranged in the rotor carrier 1 more easily as a result of the elastic deformability of the indentation 5. In other exemplary arrangements (not shown), it is also possible that the indentation 5 does not have a raised portion 5b on its base 5a.

The disk carrier connecting portion 13 has a receiving opening 15 for receiving the indentation 5, wherein the receiving opening 15 is designed as a through-opening in the disk carrier 11. The indentation 5 and the receiving opening 15 form a form-fitting connection, so that the rotor carrier 1 and the disk carrier 11 are connected to one another in a rotationally fixed and axially fixed manner. In the assembled state, the indentation 5 exerts a spring force on the disk carrier 11 in the radial direction. The indentation 5 can furthermore be elastically deformed in the axial direction owing to the raised portion 5b, so that the indentation 5 can exert a spring force on an inner edge of the receiving opening 15 in the axial direction. A force-fitting connection can thus be additionally formed between the indentation 5 and the receiving opening 15, so that a relative movement between the indentation 5 and the receiving opening 15 in the radial direction can be hindered, if not prevented. A stable connection can therefore be formed between the rotor carrier connecting portion 3 and the disk carrier connecting portion 13.

FIG. 5 shows a third exemplary arrangement for the rotor carrier 1 and for the disk carrier 11. The rotor carrier connecting portion 3 shown here likewise comprises the indentation 5 having the base 5a. The indentation 5 abuts against an outer wall of the disk carrier 11 and exerts the above-described spring force on the disk carrier 11

Instead of a raised portion 5b as in FIG. 4, the base 5a of the indentation 5 has a receiving hole 6 for receiving the disk carrier connecting portion 13. To this end, the disk carrier connecting portion 13 has a disk carrier stud 16 for engaging with the rotor carrier connecting portion 3. Upon engagement, the disk carrier stud 16 projects into the receiving hole 6. A form-fitting connection 9b between the rotor carrier connecting portion 3 and the disk carrier connecting portion 13 can therefore be formed by the receiving hole 6 and the disk carrier stud 16.

The disk carrier stud 16 furthermore has a disk carrier stud head 16a for engaging behind the receiving hole 6 of the indentation 5. The head 16a is designed to be flush with the outer wall of the hollow cylindrical portion 2 of the rotor carrier 1 at its end which is remote from the disk carrier 11.

FIG. 6 shows a fourth exemplary arrangement for the rotor carrier 1 and the disk carrier 11. Instead of an indentation 5 as in FIGS. 1 to 5, the rotor carrier connecting portion 3 here has a (rotor carrier) stud 7, which is in engagement with a receiving opening 17 of the disk carrier connecting portion 13, wherein the receiving opening 17 is designed as a receiving cavity. The rotor carrier stud 7 has a (rotor carrier stud) head 7a, which engages behind an undercut 17a provided in the receiving opening 17. A form-fitting connection 9b is thus formed in the circumferential direction of the rotor carrier 1 and the disk carrier 11. The rotor carrier 1 and the disk carrier 11 are therefore connected to one another in a rotationally fixed and axially fixed manner.

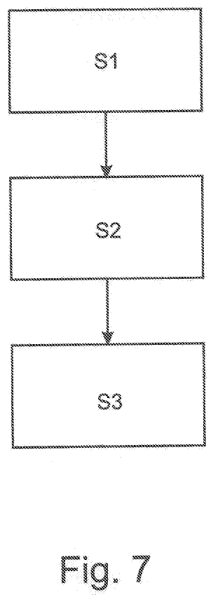

FIG. 7 shows a method for producing a system having the rotor carrier 1 and the disk carrier 11.

To this end, either the rotor carrier connecting portion 3 or the disk carrier connecting portion 13 are formed in S1, depending on which exemplary arrangement is produced.

In the first and third exemplary arrangements of FIGS. 1 to 3 or FIG. 5, the rotor carrier connecting portion 3 is firstly formed, namely the indentation 5 and possibly the receiving hole 6 at the base 5a of the indentation.

In the second and fourth exemplary arrangements of FIG. 4 or FIG. 6, the disk carrier connecting portion 13 having the receiving opening 15; 17 is initially formed. The disk carrier 11 is arranged in the rotor carrier 1 in S2.

The material-fitting or form-fitting connection 9a, 9b is formed with the aid of the rotor carrier connecting portion 3 and the disk-carrier connecting portion 13 in S3. To this end, absent corresponding connecting portion 3; 13 which was not formed in S1 is formed as required following the arrangement of the disk carrier 11 in the rotor carrier 1. The formation of the absent corresponding connecting portion 3; 13 is described below.

For the first exemplary arrangement as shown in FIGS. 1 to 3, the disk carrier connecting portion 13 is already present, namely as a region on the outer wall of the disk carrier 11 which is provided for welding to the indentation 5.

For the second exemplary arrangement according to FIG. 4, the surface of the outer wall of the rotor carrier 1 is indented by a forming tool, so that the indentation 5 having the raised portion 5b is formed by the reshaping of the rotor carrier 1. The indentation 5 forms the form-fitting connection 9b to the receiving opening 15. A cushion for holding against the forming tool is furthermore used when forming the indentation 5.

For the third exemplary arrangement according to FIG. 5, the surface of the inner wall of the disk carrier 11 is indented by a forming tool so that the disk carrier stud 16 having the head 16a is formed by the reshaping of the disk carrier 11. The disk carrier stud 16 forms the form-fitting connection 9b with the receiving hole 6 of the indentation 5. A corresponding cushion for holding against the forming tool is furthermore used when forming the disk carrier stud 17.

For the third exemplary arrangement according to FIG. 6, the surface of the outer wall of the rotor carrier 1 is indented by a forming tool so that the rotor carrier stud 7 having the head 7a is formed by the reshaping of the rotor carrier 1.

The rotor carrier stud 7 forms the form-fitting connection 9b with the receiving opening or receiving cavity 17.

1. A rotor carrier for an electric machine provided for a drive of a motor vehicle, which has, on a circumference thereof, a rotor carrier connecting portion which extends in a radial direction of the rotor carrier for connecting to a disk carrier connecting portion of a disk carrier.

2. The rotor carrier as claimed in claim 1, wherein the rotor carrier connecting portion is designed to form a material-fitting or form-fitting connection to the disk carrier connecting portion.

3. The rotor carrier as claimed in claim 1, wherein the rotor carrier connecting portion has an indentation for realizing a radial force on the disk carrier.

4. The rotor carrier as claimed in claim 3, wherein a receiving hole for receiving the disk carrier connecting portion is provided at the base of the indentation.

5. The rotor carrier as claimed in claim 1, wherein the rotor carrier connecting portion has a radially inwardly projecting rotor carrier stud for engaging with the disk carrier connecting portion.

6. The rotor carrier as claimed in claim 5, wherein the rotor carrier stud has a head for engaging behind the disk carrier connecting portion.

7. A disk carrier for a multi-disk clutch for decoupling an electric machine provided for a drive of a motor vehicle from an internal combustion engine, which has, on the outer circumference, a disk carrier connecting portion for connecting to a rotor carrier connecting portion of a rotor carrier of the electric machine.

8. A disk carrier as claimed in claim 7, wherein the disk carrier connecting portion extends in a radial direction of the disk carrier for connecting to the rotor carrier connecting portion.

9. The disk carrier as claimed in claim 7, wherein the disk carrier connecting portion is designed to form a form-fitting connection to the rotor carrier connecting portion.

10. The disk carrier as claimed in claim 7, wherein the disk carrier connecting portion has a receiving opening for receiving the rotor carrier connecting portion.

11. The disk carrier as claimed in claim 10, wherein the receiving opening has an undercut.

12. The disk carrier as claimed in claim 7, wherein the disk carrier connecting portion has a radially outwardly projecting, disk carrier stud for engaging with the rotor carrier connecting portion.

13. A system having a rotor carrier as claimed in one claim 1 and a disk carrier which has on an outer circumference thereof, a disk carrier connecting portion, wherein the rotor carrier and the disk carrier are connected to one another via the rotor carrier connecting portion and the disk carrier connecting portion.

14. A method producing system as claimed in claim 13 comprising:
forming the rotor carrier connecting portion or the disk carrier connecting portion;
arranging the disk carrier in the rotor carrier; and
forming a material-fitting or form-fitting connection with the aid of the rotor carrier connecting portion and the disk carrier connecting portion.

15. The method as claimed in claim 14, wherein the formation of the rotor carrier connecting portion or the disk carrier connecting portion comprises forming an indentation in a surface of the rotor carrier or a surface of the disk carrier.

16. The disk carrier as claimed in claim 12, wherein the rotor carrier connecting portion comprises an indentation having a base, wherein the base further comprises a receiving hole and wherein the disk carrier stud head projects into the receiving hole.

17. The disk carrier as claimed in claim 16, wherein the disk carrier stud includes a disk carrier stud head for engaging behind the receiving hole.

18. The disk carrier as claimed in claim 17, wherein the disk carrier stud head is flush with an outer wall of the rotor carrier at an end that is remote from the disk carrier.

19. The disk carrier as claimed in claim 3, wherein the rotor connecting portion has a plurality of indentations, and wherein the plurality of indentations are evenly spaced from one another in a circumferential direction.

20. The disk carrier as claim in claim 3, wherein the indentation has a base and a raised portion, the raised portion projecting radially outward.
